(19) United States
(12) Patent Application Publication
(10) Pub. No.: US 2007/0275756 A1
(43) Pub. Date: Nov. 29, 2007

(54) Apparatus and method for transmitting/receiving data using multi-channel of wireless LAN in a mobile communication terminal

(75) Inventor: Jong-Mu Choi, Gunpo-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/788,675

(22) Filed: Apr. 20, 2007

(30) Foreign Application Priority Data
May 25, 2006 (KR) 2006-0046995

(51) Int. Cl. H04Q 7/32

(52) U.S. Cl. 455/557; 370/338

(57) ABSTRACT

The present invention relates to a mobile communication terminal having a wireless LAN module. The wireless LAN module checks if used channel information exists. A mobile communication module transmits an idle channel information list. A channel list manager transmits the idle channel information list using the used channel information checked by the wireless LAN module, receives channel information selected from a receiving terminal, and sets the channel.

### PRIORITY

This application claims priority under 35 U.S.C. § 119 to an application filed in the Korean Intellectual Property Office on May 25, 2006 entitled “Apparatus and method for Transmitting/Receiving Data Using Multi-Channel of Wireless LAN in a Mobile Communication Terminal” and assigned Serial No. 2006-46995, the contents of which are incorporated herein by reference.

### BACKGROUND OF THE INVENTION

1. Field of the Invention

The present invention relates to a mobile communication terminal having a wireless LAN (Local Area Network) module, and particularly to an apparatus and a method for data transmission using multi-channel with a wireless LAN module.

2. Description of the Related Art

A wireless LAN system uses the Institute of Electrical and Electronics Engineers (IEEE) 802.11a/b/g MAC/PHY standard. The wireless LAN system provides packet communication services to a terminal having a wireless LAN, such as a mobile communication terminal, a Personal Digital Assistant (PDA) or a notebook computer within a certain distance around an access point (AP).

Early wireless LANs offered radio waves in a range limited to 10 m. In the year of 2000, radio waves have been extended to a range of 50˜250 m. A transmission rate of 1 to 54 Mbps is supported according to standards so that the wireless LAN can transmit and receive multimedia information. In addition, the wireless LAN has mobility and security. Thus, the wireless LAN systems are useful to temporally install and use a network in places such as a department, a hospital, a museum, a conference room, etc.

The wireless LAN systems perform data transmission based on Carrier Sense Multiple Access/Collision Avoidance (CSMA/CA) scheme. In CSMA/CA scheme, a transmitting terminal transmits a signal indicating the intent to transmit to a receiving terminal before actually transmitting data, and then transmits data to the receiving terminal only when an ACK is received from the receiving terminal. Here, if there is another terminal transmitting data on the same channel, the data transmission is delayed to avoid collision of wireless radio waves while communicating. A detailed description will be described below with reference to FIGS. 1A to 1C.

FIGS. 1A to 1C illustrate data transmission process for a conventional wireless LAN system. Referring to FIGS. 1A to 1C, the conventional wireless LAN system includes a transmitting terminal 103 for transmitting data, a receiving terminal 105 for receiving the data, and terminals 101 and 107 in an idle state.

Receiving terminal 105 and idle terminal 101 are located in a transmission range 110 of transmitting terminal 103. Transmitting terminal 103 and idle terminal 107 are located in a transmission range 120 of receiving terminal 105.

As shown in FIG. 1B, a Request To Send (RTS) frame 112 is transmitted to terminals 101 and 105 located in transmission range 110 of terminal 103 before transmitting terminal 103 transmits data to receiving terminal 105. Thus, the data transmission of idle terminal 101 is delayed.

When the RTS frame is received, receiving terminal 105 transmits a Confirm To Send (CTS) frame 122 to terminals 103 and 107 located in transmission range 120 of receiving terminal 105, as shown in FIG. 1C. Thus, the data transmission of idle terminal 107 is delayed.

The RTS and CTS frames include size and transmission rate of data to be transmitted so that terminals 101 and 107 in the idle state can identify waiting time for the data transmission.

In the above method, only a single channel among all channels (3 channels in IEEE 802.11b and 802.11g, and 12 channels in IEEE 802.11a) is available, but a plurality of channels cannot be used simultaneously.

### SUMMARY OF THE INVENTION

An object of the present invention is to solve at least the above problems and/or disadvantages and to provide at least the advantages below. Accordingly, an object of the present invention is to provide an apparatus and a method for data transmission/reception using multi-channel.

Another object of the present invention is to provide an apparatus and a method for checking an available channel information list and transmitting the channel information list to a receiving terminal through a mobile communication module.

Another object of the present invention is to provide an apparatus and a method for checking an available channel information and selecting a channel to be set.

According to an aspect of the present invention, there is provided an apparatus for transmitting data using multi-channel in a mobile communication terminal having a wireless LAN including a wireless LAN module for checking whether used channels exist; a mobile communication module for transmitting an idle channel information list; and a channel list manager for generating the idle channel information list using the used channel information checked through the wireless LAN module, and for receiving set channel information and setting a channel to be used.

According to another aspect of the present invention, there is provided an apparatus for receiving data using multi-channel in a mobile communication terminal having a wireless LAN including a wireless LAN module for checking used channel information; a mobile communication module for receiving an idle channel information list and for transmitting set channel information; and a channel list manager for determining a channel to be used using the idle channel information list and the used channel information checked through the wireless LAN module, and for adding the channel to be used into the set channel information.

According to a further aspect of the present invention, there is provided a method for transmitting data using multi-channel in a mobile communication terminal having a wireless LAN including checking if a data transmission event occurs; when the data transmission event occurs, generating an idle channel information list; transmitting the idle channel information list to a receiving terminal; receiving set channel information from the receiving terminal; and transmitting data to the receiving terminal using the channel included in the set channel information.

According to still another aspect of the present invention, there is provided a method of receiving data using multi-channel in a mobile communication terminal having a wireless LAN including checking if an idle channel information list is received from a transmitting terminal; when the idle channel information list is received, generating an idle channel information list of a receiving terminal; generating set channel information after generating the idle channel information list of the receiving terminal; and transmitting the set channel information to the transmitting terminal.

### BRIEF DESCRIPTION OF THE DRAWINGS

The above and other objects, features and advantages of the present invention will become more apparent from the following detailed description when taken in conjunction with the accompanying drawings in which:

FIGS. 1A, 1B and 1C illustrate data transmission process for a conventional wireless LAN system;

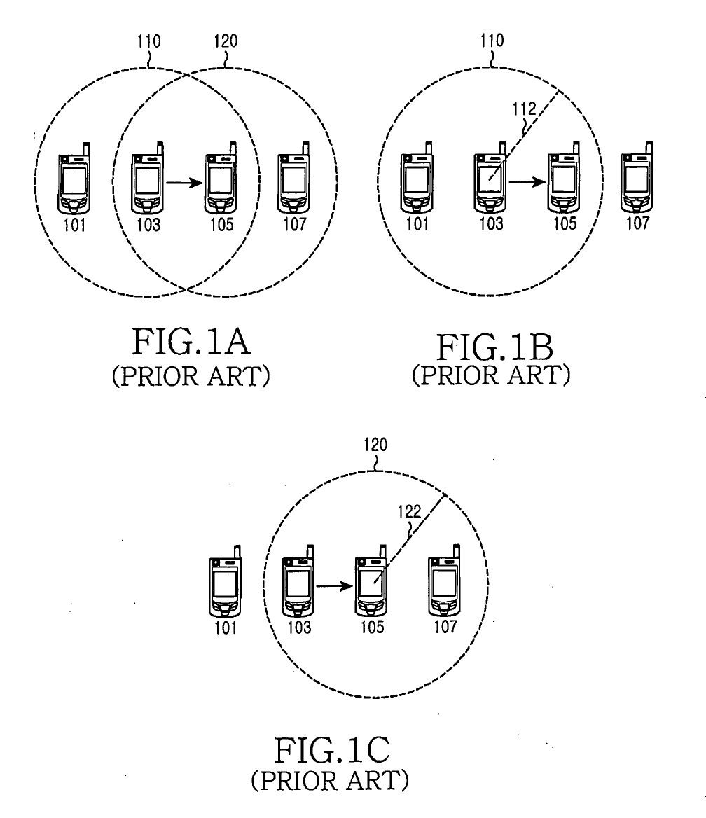

FIG. 2 is a block diagram of a transmitter using multi-channel according to the present invention;

FIG. 3 is a flowchart of a process of data transmission using multi-channel according to the present invention;

FIG. 4 is a flowchart of a process of channel selection using multi-channel according to the present invention; and

FIGS. 5A, 5B, 5C, 5D, 5E and 5F illustrate a configuration of a wireless LAN system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The used channel information, which is the information of channels used by other terminals, is checked through channel scan in a wireless LAN module. The idle channel information list includes the information of unused channels among available channels (3 channels in IEEE 802.11b and 802.11g, and 12 channels in 802.11a). The used channel information and the idle channel information list are used in transmitting/receiving terminals.

The set channel information means a channel selected from sharable channels included in the idle channel information list of transmitting/receiving terminals.

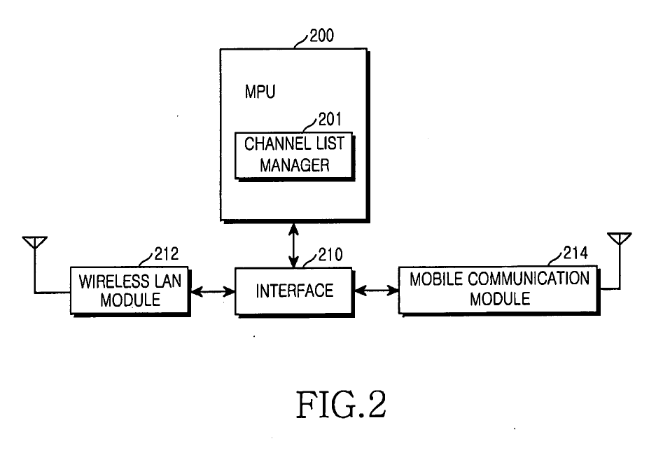

Referring to FIG. 2, the mobile communication terminal includes a wireless LAN module 212, a mobile communication module 214 and a Micro-Processor Unit (MPU) 200 acting as a controller. The MPU 200 includes a channel list manager 201 for checking available channels.

MPU 200 controls the overall operation of the mobile communication terminal. For example, MPU 200 is responsible for processing and controlling voice communication and data communication. In addition to the typical functions, MPU 200 issues commands to channel list manager 201 to generate and manage an idle channel information list when data transmission event occurs.

If MPU 200 receives the idle channel information list from the transmitting terminal upon receiving data, MPU 200 instructs channel list manager 201 to generate the set channel information and transmit it to the transmitting terminal. A detailed description of the typical processing and controlling operation of MPU 200 will be omitted.

Channel list manager 201 generates the idle channel information list using the used channel information checked through wireless LAN module 212 under the control of MPU 200. Under the control of MPU 200, channel list manager 201 compares the idle channel information list of the transmitting terminal with that of the receiving terminal and selects a channel from sharable channels included in the idle channel information lists, thereby generating set channel information.

Wireless LAN module 212 performs channel scanning and checks used channel information under the control of MPU 200. Mobile communication module 214 transmits the idle channel information list and receives the set channel information in addition to communication for the typical call connection.

Interface 210 is used for connecting wireless LAN module 212 to mobile communication module 214, transfers the used information checked by wireless LAN module 212 to channel list manager 201. Interface 210 transfers the set channel information and the idle channel information list received from mobile communication module 214 to channel list manager 201.

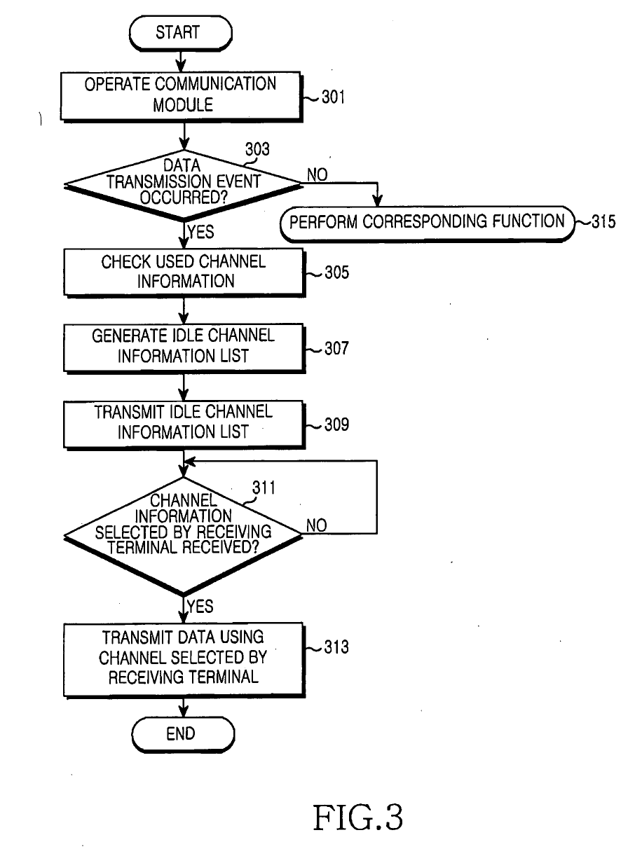

Referring to FIG. 3, MPU 200 operates a communication module in step 301. The communication module includes a wireless LAN module 212 for checking used channel information and a mobile communication module 214 for transmitting an idle channel information list to the receiving terminal.

In step 303, MPU 200 checks if a data transmission event occurs. If the data transmission event does not occur, MPU 200 proceeds to step 315 to perform the corresponding function (e.g.: waiting mode).

Meanwhile, if the data transmission event occurs, MPU 200 proceeds to step 305 to perform channel scanning through wireless LAN module 212 and check used channel information. In other words, when data to be transmitted is buffered in the mobile communication terminal, the information of the transmitting terminal (i.e. mobile communication terminal ID) is checked.

Next, MPU 200 proceeds to step 307 to generate an idle channel information list of the transmitting terminal to check the idle channels of the transmitting terminal using the used channel information checked in step 305. In step 309, MPU 200 transmits the idle channel information list of the transmitting terminal to the receiving terminal through mobile communication module 214. The idle channel information list can be transmitted by checking the information of the receiving terminal when a data transmission event occurs in step 303 and using a control channel defined in mobile communication networks (such as WCDMA, CDMA, GSM, etc.).

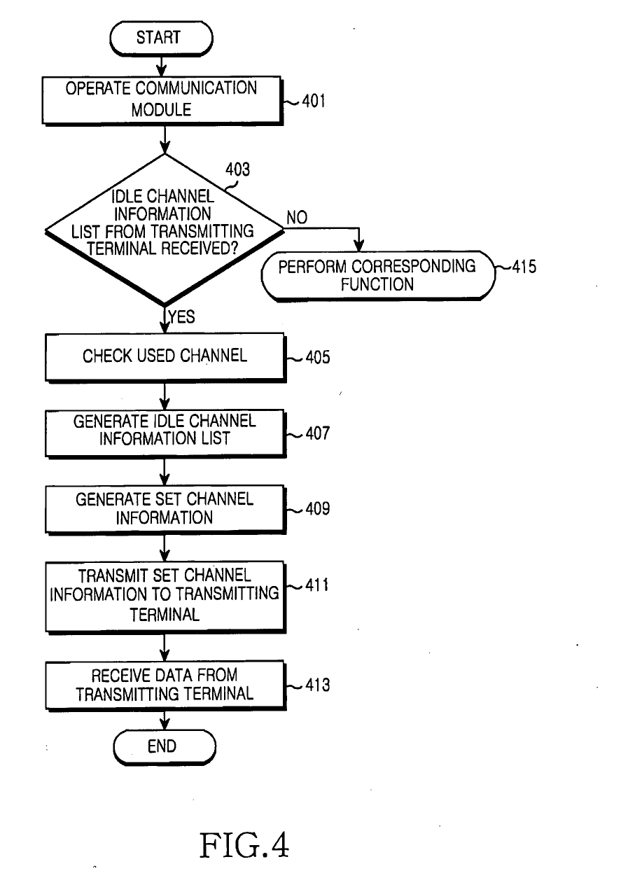

After transmitting the idle channel information list, MPU 200 proceeds to step 311 to check if the receiving terminal receives set channel information. The set channel information is selected from sharable channels included in the idle channel information lists of the transmitting and receiving terminals. It will be described in detail in FIG. 4.

If the set channel information is received, MPU 200 proceeds to step 313 to transmit the data to the receiving terminal using a channel included in the set channel information, and ends this algorithm.

Referring to FIG. 4, MPU 200 operates a communication module in step 401. The communication module includes a wireless LAN module 212 for checking used channel information and a mobile communication module 214 for transmitting an idle channel information list to the receiving terminal.

In step 403, MPU 200 checks whether an idle channel information list is received from the transmitting terminal. If the idle channel information list is not received, MPU 200 proceeds to step 415 to perform a corresponding function (e.g.: waiting mode).

Meanwhile, if the idle channel information list is received in step 403, MPU 200 proceeds to step 405 to check the used channel information through wireless LAN module 212. In step 407, MPU 200 generates an idle channel information list of a receiving terminal and checks the idle channels of the receiving terminal using the used channel information checked in step 405.

Next, MPU 200 proceeds to step 409 to compare the idle channel information list of the receiving terminal with the idle channel information list received from the transmitting terminal. A channel is then selected from sharable channels included in the idle channel information lists of the transmitting and receiving terminals. Thereby, the set channel information is generated.

In step 411, MPU 200 transmits the set channel information to the transmitting terminal using a control channel defined in mobile communication systems (WCDMA, CDMA, GSM, etc.). In step 413, MPU 200 receives data from the transmitting terminal and ends this algorithm.

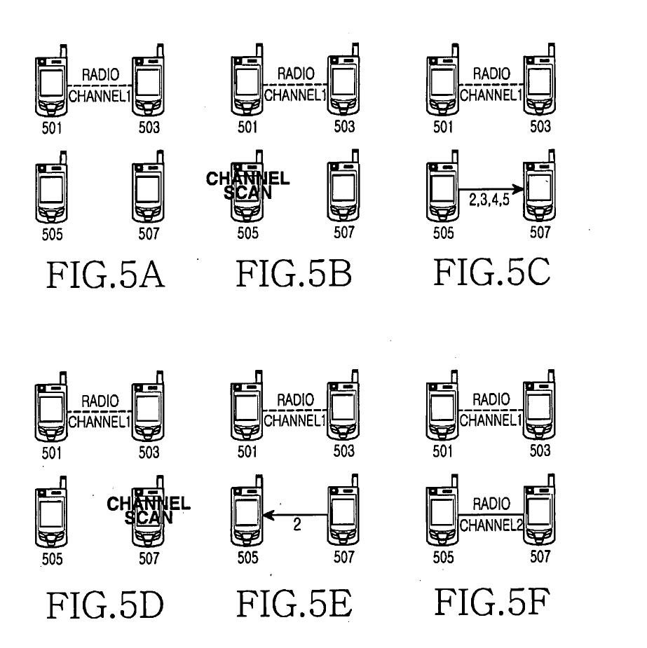

Referring to FIG. 5A, mobile communication terminals 501 and 503 transmit and receive data through channel 1.

As shown in FIG. 5B, if a terminal 505 that is not carrying out the transmission and reception of data, tries to transmit data, terminal 505 checks a used channel through channel scanning using wireless LAN module 212. Terminal 505 generates a channel information list (channels 2, 3, 4 and 5) including channel information available in transmitting terminal 505.

If the channel information list is transmitted to receiving terminal 507 through data communication as shown in FIG. 5C, receiving terminal 507 generates the available channel list through wireless LAN module 212 as shown in FIG. 5D. As shown in FIG. 5E, receiving terminal 507 compares the generated channel list with the channel information list received from transmitting terminal 505, and transmits to transmitting terminal 505 the frame including the information of channel to be used.

FIG. 5F illustrates mobile communication terminals 505 and 507 selecting one of the unused channels and performing data communication using the selected channel.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

As stated above, the present invention can use multi-channel upon data transmission and reception with a wireless LAN module, and thus can improve performance of data transmission.

While the present invention has been shown and described with reference to preferred embodiments thereof, it will be understood by those skilled in the art that various changes in form and details may be made therein without departing from the spirit and scope of the present invention as further defined by the appended claims.

What is claimed is:

1. An apparatus for transmitting data using multi-channel in a mobile communication terminal having a wireless LAN, comprising:
a wireless LAN module for checking if used channel information exists;
a mobile communication module for transmitting an idle channel information list; and
a channel list manager for generating the idle channel information list using the used channel information checked in the wireless LAN module, and transmitting it, and for receiving set channel information and setting the channel to be used.

2. The apparatus of claim 1, further comprising:
a controller for instructing the channel list manager to generate and manage the idle channel information list, and for controlling an overall operation including the data transmission and reception of the mobile communication terminal.

3. The apparatus of claim 2, wherein the idle channel information list includes the information of unused channels among available channels.

4. The apparatus of claim 1, wherein the set channel information is a channel selected from the channels sharable by a receiving terminal among the channels included in the idle channel information list.

5. An apparatus for receiving data using multi-channel in a mobile communication terminal having a wireless LAN, comprising:
a wireless LAN module for checking used channel information;
a mobile communication module for receiving an idle channel information list and transmitting set channel information; and
a channel list manager for determining a channel to be used using the idle channel information list and the used channel information checked through the wireless LAN module, and for adding the channel to be used into the set channel information.

6. The apparatus of claim 5, further comprising:
a controller for instructing the channel list manager to generate the idle channel information list and set channel information and managing them, and for controlling an overall operation including the data transmission and reception of the mobile communication terminal.

7. The apparatus of claim 6, wherein the set channel information is a channel selected from sharable channels included in the received idle channel information list.

8. The apparatus of claim 7, wherein the idle channel information list includes the information of unused channels among available channels.

9. A method of transmitting data using multi-channel in a mobile communication terminal having a wireless LAN, comprising the steps of:
checking if a data transmission event is generated;
generating an idle channel information list when the data transmission event is generated;
transmitting the idle channel information list to a receiving terminal;
receiving set channel information from the receiving terminal; and
transmitting data to the receiving terminal using a channel included in the set channel information.

10. The method of claim 9, wherein the idle channel information list includes the information of unused channels among available channels.

11. The method of claim 9, wherein the set channel information is a channel selected from the channels sharable by the receiving terminal among the channels included in the idle channel information list.

12. A method of receiving data using multi-channel in a mobile communication terminal having a wireless LAN, comprising the steps of:
checking if an idle channel information list is received from a transmitting terminal;
generating an idle channel information list of a receiving terminal when the idle channel information is received;
generating set channel information after generating the idle channel information list of the receiving terminal; and
transmitting the set channel information to the transmitting terminal.

13. The method of claim 12, further comprising receiving the data from the transmitting terminal after transmitting the set channel information to the transmitting terminal.

14. The method of claim 12, wherein the set channel information is a channel selected from sharable channels included in the received idle channel information list.

15. The method of claim 12, wherein the idle channel information list includes the information of unused channels among available channels.

16. A mobile communication system for transmitting data using multi-channel, comprising:
a transmitting device for generating an idle channel information list using an used channel information checked in a wireless LAN module, and
a receiving device for determining a channel to be used using the idle channel information list and the used channel information checked through the wireless LAN module, and for adding the channel to be used into the set channel information.

17. The apparatus of claim 16, wherein the idle channel information list includes the information of unused channels among available channels.

18. The apparatus of claim 16, wherein the set channel information is a channel selected from the channels sharable by a receiving terminal among the channels included in the idle channel information list.

19. A computer-readable recording medium having recorded thereon a program for transmitting data using multi-channel in a mobile communication terminal having a wireless LAN, comprising:
a first segment, for checking if a data transmission event is generated;
a second segment, for generating an idle channel information list when the data transmission event is generated;
a third segment, for transmitting the idle channel information list to a receiving terminal;
a fourth segment, for receiving set channel information from the receiving terminal; and
a fifth segment, for transmitting data to the receiving terminal using a channel included in the set channel information.

20. A computer-readable recording medium having recorded thereon a program receiving data using multi-channel in a mobile communication terminal having a wireless LAN, comprising:
a first segment, for checking if an idle channel information list is received from a transmitting terminal;
a second segment, for generating an idle channel information list of a receiving terminal when the idle channel information is received;
a third segment, for generating set channel information after generating the idle channel information list of the receiving terminal; and
a fourth segment, for transmitting the set channel information to the transmitting terminal.
